(19) United States
(12) Patent Application Publication
(10) Pub. No.: US 2014/0067900 A1
(43) Pub. Date: Mar. 6, 2014

(54) STREAM PROCESSING DEVICE, SERVER, AND STREAM PROCESSING METHOD

(71) Applicant: HITACHI, LTD., Tokyo (JP)

(72) Inventor: Yusuke FUKUMURA, Tokyo (JP)

(73) Assignee: HITACHI, LTD., Tokyo (JP)

(21) Appl. No.: 13/958,751

(22) Filed: Aug. 5, 2013

(30) Foreign Application Priority Data
Sep. 4, 2012 (JP) 2012-194346

(51) Int. Cl. H04L 29/06

(52) U.S. Cl. CPC H04L 65/4069
USPC 709/201

(57) ABSTRACT

A stream processing device executes query processing with respect to data included in a packet input from a network with a duplication unit that duplicates the input packet into a plurality of packets, a protocol processing unit that executes protocol processing corresponding to the network with respect to one packet among the duplicated packets to determine whether or not an error is present, a storage unit that stores a management flag indicating a result of the protocol processing, a data extraction unit that extracts data necessary for the query processing from another packet among the duplicated packets, a query processing unit that executes the query processing with respect to the extracted data, and outputs data including a result of the query processing. An output control unit determines whether to output the data output from the query processing unit from the stream processing device on the basis of the management flag.

### INCORPORATION BY REFERENCE

The present application claims priority from Japanese application JP2012-194346 filed on Sep. 4, 2012, the content of which is hereby incorporated by reference into this application.

### BACKGROUND OF THE INVENTION

1. Field of the Invention

The present invention relates to a stream processing device.

2. Background Art

A stream processing technology is a technology of processing flow data such as sensor data that is momentarily generated at a high speed. In a case where a server provided in a database management system processes data without using stream processing, the server stores the input flow data in a HDD (Hard Disk Drive), and executes a process designated for data that is readout from the HDD. Conversely, in a case where the server processes data by the stream processing, when data is written in a memory provided to the server, the server instantly executes a process designated for the data. Accordingly, the stream processing technology is suitable for a process in which real-time properties are required.

FIG. 12 is a block diagram illustrating a server 101 that executes stream processing in the related art.

The server 101 is a computer in the related art provided with a CPU 102, a memory 103, an input network adaptor 105, an IO hub 104, and an output network adaptor 106.

When input data such as sensor data is input to the server 101 from a network, the server 101 receives the input data through the input network adaptor 105. The input network adaptor 105 executes protocol processing of a lower layer in the network with respect to the input data.

The CPU 102 receives data, which is fetched from the input data by the protocol processing, through the IO hub 104. In addition, the CPU 102 stores the data fetched from the input data in the memory 103.

The CPU 102 executes the protocol processing of an upper layer of the network with respect to the data stored in the memory 103 to obtain application data such as sensor data. In addition, the CPU 102 obtains output data from the obtained application data and a plurality of pieces of sensor data (internal state) accumulated in the memory 103 by stream processing software installed in the memory 103.

The CPU 102 executes the protocol processing of the upper layer of the network with respect to the output data so as to transmit the output data that is obtained to other apparatuses through the network, and then transmits the output data to the output network adaptor 106. The output network adaptor 106 executes the protocol processing of the lower layer of the network with respect to the output data that is transmitted, and then transmits the output data to other apparatuses.

In recent years, demand for real-time processing has increased in financial fields and industrial equipment control fields, and systems in which the stream processing is applied have increased. Accordingly, in the stream processing, it is preferable that a response time (time taken before data is output from a server after the data is input to the server) be improved.

As described above, the response time includes not only a processing time by the stream processing software, but also a protocol processing time of the network. Therefore, it is necessary for both of or any of the processing time by the stream processing software and the protocol processing time of the network to be reduced for improvement of the response time.

In the related art, a technology, in which a throughput of the processing by the stream processing software is increased by pipelining of the processing of the plurality of pieces of input data, and the processing time is reduced, is suggested (for example, refer to JP-A-2009-134391).

In addition, with regard to the protocol processing of the network, a technology in which in protocol processing with respect to a packet, the packet is processed after being divided into a packet prefix and a data block is suggested (for example, refer to JP-A-08-265280).

With regard to the increase in speed of the stream processing disclosed in JP-A-2009-134391, the stream processing is executed in parallel to reduce the total processing time of the stream processing in a case where a plurality of inputs are made in a short time, and in a case where the plurality of inputs are not made in a short time, the response time of the stream processing itself is not reduced.

On the other hand, generally, it is necessary for the protocol processing of the network to be executed by the network adaptor and, an OS provided to the server and to be sequentially executed according to a predetermined rule. Therefore, it is difficult for the speed of the protocol processing of the network to be increased.

In the processing disclosed in JP-A-08-265280, the technology of processing the packet in parallel after dividing the packet into the packet prefix and the data block is suggested. However, since the stream processing software does not extract data necessary for executing the stream processing from the packet, it is difficult to obtain a normal stream processing result.

### SUMMARY OF THE INVENTION

An object of the invention is to provide a device that normally executes stream processing and which is capable of reducing a response time of the stream processing.

A representative example of the invention is as follows. That is, according to an embodiment of the invention, there is provided a stream processing device that executes query processing with respect to data included in a packet input from a network. The stream processing device includes a duplication unit that duplicates the input packet into a plurality of packets, a protocol processing unit that executes protocol processing corresponding to the network with respect to one packet among the duplicated packets to determine whether or not an error is present in the packet, a storage unit that stores a management flag indicating a result of determination by the protocol processing, a data extraction unit that extracts data necessary for the query processing from another packet among the duplicated packets, a query processing unit that executes the query processing with respect to the extracted data, and outputs data including a result of the query processing, and an output control unit that determines whether or not to output the data, which is output from the query processing unit, from the stream processing device on the basis of the management flag.

According to the embodiment of the invention, stream processing is normally executed, and a response time of the stream processing may be reduced.

### BRIEF DESCRIPTION OF THE DRAWINGS

FIG. 1 is a block diagram illustrating a computer system of an example;

FIG. 2 is a block diagram illustrating an internal configuration of a stream processor of the example;

FIG. 3 is a block diagram illustrating details of a process in a stream processing unit of the example;

FIG. 4A is an explanatory diagram illustrating an abnormality detection system using a server of the example;

FIG. 4B is an explanatory diagram illustrating an abnormality determination method in the abnormality detection system using the server of the example;

FIG. 5 is a flowchart illustrating a process of acquiring settings for allowing the stream processing unit of the example to execute stream processing;

FIG. 6 is an explanatory diagram illustrating a format of a packet input to the stream processing unit of the example;

FIG. 7 is a flowchart illustrating the stream processing by the stream processing unit of the example;

FIG. 8 is an explanatory diagram illustrating a TCP/IP packet that is received by the stream processing unit of the example;

FIG. 9 is an explanatory diagram illustrating a management flag of the example;

FIG. 10 is an explanatory diagram illustrating an input condition for fetching data from an input register of the example;

FIG. 11 is an explanatory diagram illustrating an output condition for fetching data from an output register of the example; and

FIG. 12 is a block diagram illustrating a server that executes stream processing in the related art.

### DETAILED DESCRIPTION OF THE INVENTION

Hereinafter, a stream processing device, which reduces a response time by executing protocol processing of a network and query processing in stream processing in parallel, will be described.

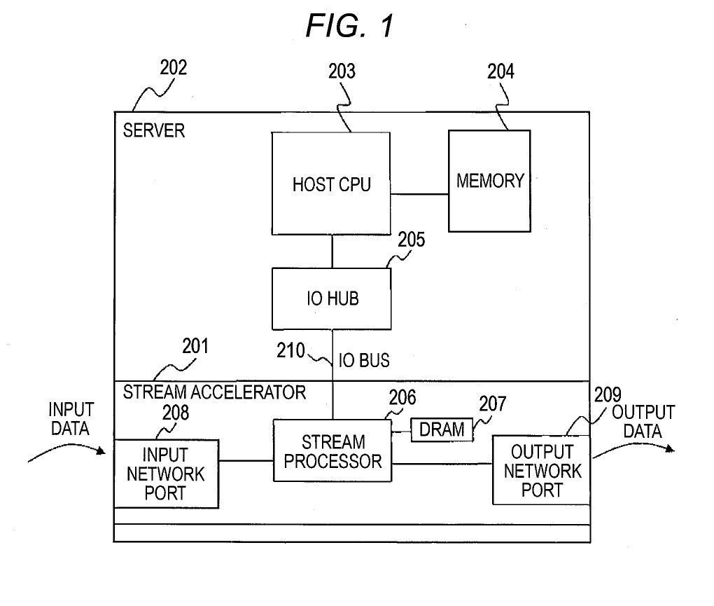

FIG. 1 shows a block diagram illustrating a server 202 of the example.

The server 202 of the example is a computer that is connected to a network, and executes stream processing with respect to input data. The server 202 includes a stream accelerator 201, a host CPU 203, a memory 204, an IO hub 205, and an IO bus 210.

In addition, the server 202 receives information input by a user (a developer, a manager, or the like of the server 202), and thus the server 202 may include an input device provided with a keyboard, a mouse, or the like, or the server 202 may be connected to the input device provided with the keyboard, the mouse, or the like.

The host CPU 203 is an arithmetic unit. The host CPU 203 may be a processor other than a CPU (Central Processing Unit) as long as the host CPU 203 is capable of executing arithmetic processing. In addition, the host CPU 203 may include a plurality of processors. The host CPU 203 in the example executes query processing in the stream processing.

The memory 204 is a storage region that stores data input to the server 202, and the like. The host CPU 203 of the example reads out one or a plurality of pieces of data stored in the memory 204, and executes query processing designated by a user with respect to the read-out data.

The IO hub 205 transmits data input to the IO hub 205 by the stream accelerator 201 to the host CPU 203. In addition, the IO hub 205 transmits data input to the IO hub 205 by the host CPU 203 to the stream accelerator 201. The IO hub 205 and the stream accelerator 201 are connected to each other by the IO bus 210.

The stream accelerator 201 is a device that executes stream processing with respect to the input data, and reduces a response time by the following process of the example. The stream accelerator 201 may have an expansion card shape that may be installed in a general computer. The stream accelerator 201 includes a stream processor 206, a DRAM 207, an input network port 208, and an output network port 209.

The input network port 208 is a port that receives data input to the server 202, and transmits the input data to the stream processor 206. The output network port 209 is a port that outputs the data output from the stream processor 206 from the server 202.

The stream processor 206 is a processor that executes predetermined network processing and query processing with respect to data input to the server 202. The DRAM 207 is a storage region that is used by the stream processor 206 to execute the query processing.

In addition, in the example, when arriving at the server 202, data input to the server 202 is included in a packet, which is a communication unit in a network. Accordingly, in the following description, the server 202 is described as receiving a packet including data from a network connected to the server 202.

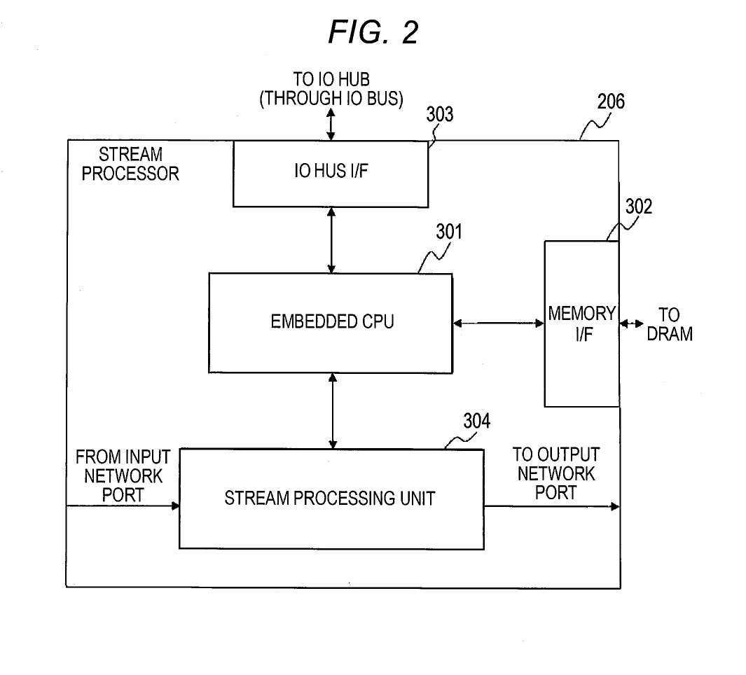

FIG. 2 shows a block diagram illustrating an internal configuration of the stream processor 206 of the example.

The stream processor 206 includes an embedded CPU 301, a Memory I/F 302, an IO bus I/F 303, and a stream processing unit 304.

The IO bus I/F 303 is an interface that is connected to the IO hub 205 through the IO bus 210 shown in FIG. 1. The Memory I/F 302 is an interface that allows the stream processor 206 to be connected to the DRAM 207 when executing query processing.

The stream processing unit 304 executes protocol processing of an input network, protocol processing of an output network, and query processing (a part of stream processing). The protocol processing of the input network of the example is predetermined processing that is executed with respect to a packet according to a network connected to the server 202, and is a process of executing query processing with respect to data included in a packet that is input.

In addition, the protocol processing of the output network of the example is a process of outputting data after being subjected to the query processing from the server 202 to a network, and for example, the protocol processing is a process of storing data after being subjected to the query processing in a packet.

The embedded CPU 301 executes a data transmission and reception control between the host CPU 203 of the server 202 and the stream processing unit 304, and a data transmission and reception control between the DRAM 207 and the stream processing unit 304.

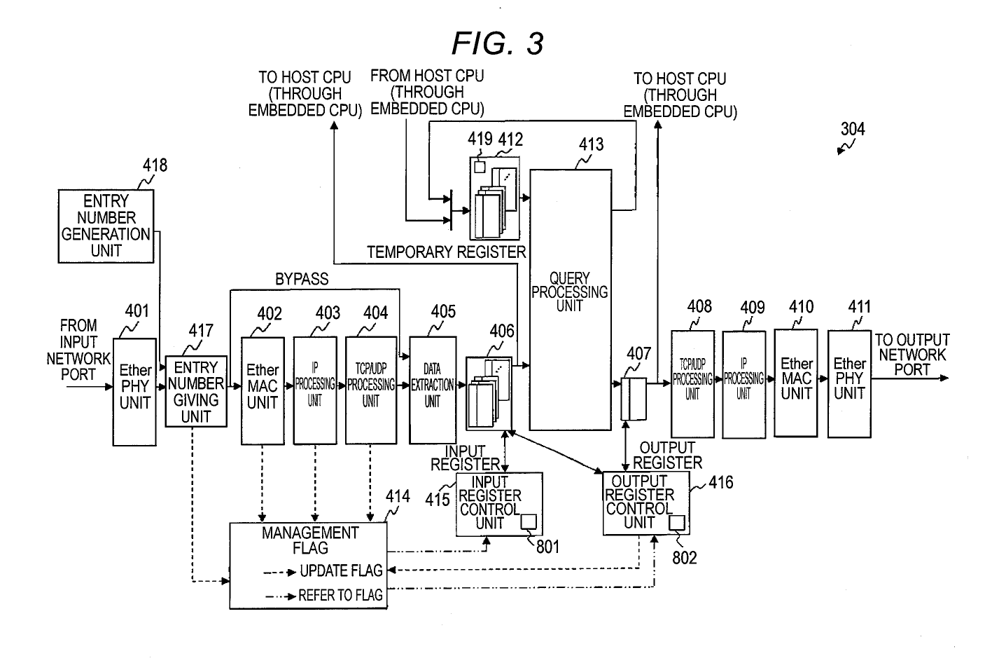

FIG. 3 shows a block diagram illustrating details of a process in the stream processing unit 304 of the example.

Respective blocks shown in FIG. 3 show processes by the stream processing unit 304, but the stream processing unit 304 may include a plurality of physical devices (processing units) that execute processes, shown in the respective blocks. In addition, the stream processing unit 304 may include software that executes the processes shown in the respective blocks.

In the following description, the stream processing unit 304 shown in FIG. 3 includes physical processing units that execute the respective blocks. In addition, the stream processing unit 304 shown in FIG. 3 includes a storage unit such as a register, and temporarily stores data or the like that is used for the processes in the storage unit.

The stream processing unit 304 includes an EtherPHY unit 401, an EtherMAC unit 402, an IP processing unit 403, a TCP/UDP processing unit 404, a data extraction unit 405, a TCP/UDP processing unit 408, an IP processing unit 409, an EtherMAC unit 410, an EtherPHY unit 411, a query processing unit 413, an input register control unit 415, an output register control unit 416, an entry number giving unit 417, and an entry number generation unit 418 as the processing units.

In addition, the stream processing unit 304 includes an input register 406, an output register 407, and a temporary register 412 as storage units. In addition, the stream processing unit 304 includes a storage unit that stores a management flag 414.

The following example is an example in which a network to which the server 202 is connected is a network implemented by Ethernet (registered trademark, the same shall apply hereinafter). Accordingly, data, which is an object of the following stream processing, is included in a payload portion of a packet in Ethernet, and is input to the stream processing unit 304.

However, the data, which is an object of the stream processing in the example, is not limited to be included in the packet of the Ethernet, and may be transmitted to the server 202 by a communication unit according to a network to which the server 202 is connected.

With respect to the packet input from the input network port 208, the protocol processing of the input network and the protocol processing of the output network are executed in a sequence according to the protocol of the network to which the server 202 is connected. As an example, the stream processing unit 304 shown in FIG. 3 executes protocol processing in a case where the server 202 uses a TCP/IP protocol in a network of Ethernet.

However, the protocol processing of the input network and the protocol processing of the output network, which are executed by the stream processing unit 304, are not necessarily the protocol processing related to the TCP/IP protocol on Ethernet, and may be processing according to a protocol provided in the networks.

The EtherMAC unit 402, the IP processing unit 403, and the TCP/UDP processing unit 404 execute the protocol processing of the input network of the stream processing unit 304 in FIG. 3. In addition, the TCP/UDP processing unit 408, the IP processing unit 409, and the EtherMAC unit 410 execute the protocol processing of the output network of the stream processing unit 304 in FIG. 3.

The EtherPHY unit 401 converts a packet of an analog signal which is received through the input network port 208 to a packet of a digital signal. The EtherPHY unit 411 converts a packet of a digital signal which is output from the EtherMAC unit 410 to a packet of an analog signal.

The data extraction unit 405 is a processing unit configured to extract data which is necessary for the query processing from a packet that is input.

The input register 406 is a register having at least one storage region in which data necessary for the query processing is stored. The input register 406 has the same number of storage regions as the number of entry numbers that are given to the packet by the entry number giving unit 417. In addition, the entry numbers that are given to the packet may be allocated to respective storage regions of the input register 406.

The output register 407 is a register having a storage region in which results of the query processing are stored. The output register 407 has storage regions of a number according to the content of the query processing by the query processing unit 413.

The temporary register 412 is a register having at least one storage region in which processing results that may be obtained by the query processing by the host CPU 203 are stored. In addition, the temporary register 412 may store the results partway through the processing by the query processing unit 413.

Furthermore, the temporary register 412 includes a temporary result termination flag 419. The temporary result termination flag 419 is a flag indicating whether or not the results of the processing by the host CPU 203 is stored in the temporary register 412.

The input register control unit 415 controls reading-out from the input register 406 and writing to the input register 406. The input register control unit 415 has an input condition 801.

The input condition 801 is information indicating a condition for data to be input to the query processing unit 413 among a plurality of pieces of data stored in the input register 406.

The output register control unit 416 controls reading-out from the input register 406 and the output register 407, and writing to the output register 407. The output register control unit 416 has an output condition 802.

The output condition 802 is information indicating a condition for determining whether or not to output the data stored in the output register 407 from the server 202.

The query processing unit 413 is a processing unit that executes query processing designated by a user with respect to the results of the query processing by the host CPU 203, and the data that is stored in the input register 406. When the query processing unit 413 executes the query processing, stream processing by the stream processing unit 304 is executed.

The management flag 414 is information indicating a processing result of the protocol processing of the input network. The management flag 414 is stored in the storage unit provided to the stream processing unit 304.

The entry number generation unit 418 is a processing unit that generates an entry number unique to each packet so as to manage packets input to the stream processing unit 304. With regard to the entry number generation unit 418, a predetermined number of entry numbers may be designated by a user. In addition, the entry number generation unit 418 may retain the same number of entry numbers as the number of storage regions provided to the input register 406.

The entry number giving unit 417 is a processing unit that gives a number generated by the entry number generation unit 418 to a packet. The entry number generation unit 418 inputs the entry number to the entry number giving unit 417 according to instruction of the entry number giving unit 417.

In addition, the entry number giving unit 417 duplicates the packet into at least two packets, and input one packet that is duplicated to the data extraction unit 405, and inputs the other packet to the EtherMAC unit 402. In addition, in the protocol processing of the input network, when the duplicated packets are processed in parallel, the entry number giving unit 417 may duplicate the packet into three or more packets.

In the example, the stream processing in the server 202 is executed by allowing the host CPU 203 and the query processing unit 413 to execute query processing, respectively.

The host CPU 203 executes the query processing of the host CPU 203 using data from data having arrived at the server 202 before a predetermined period of time to the latest data (that is, internal state) among data accumulated in the memory 204. In addition, the host CPU 203 inputs results of the query processing by the host CPU 203 to the stream processing unit 304, and the query processing unit 413 executes query processing (different from the query processing in the host CPU 203) of the query processing unit 413 according to the processing results input from the host CPU 203, and the latest data.

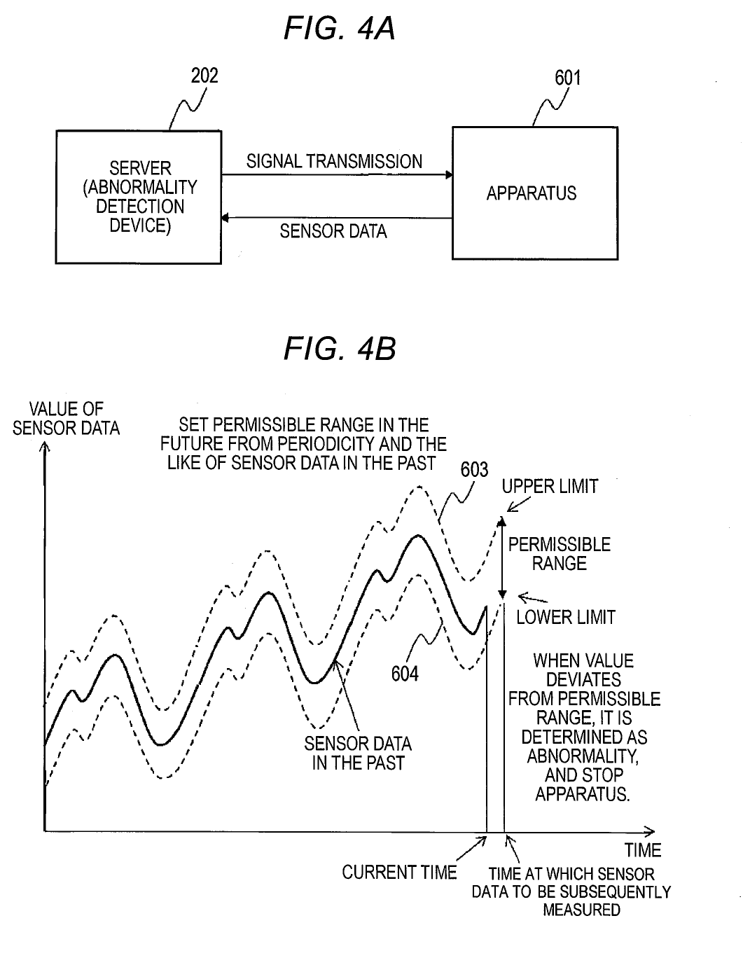

In the following description, stream processing of the example will be described with reference to an example in which the server 202 is a computer for abnormality detection system implementation. However, the server 202 of the example may be applied to a system that executes various kinds of stream processing, and thus the server 202 is not a computer for mounting an abnormality detection system only which is shown in FIG. 4A.

FIG. 4A shows an explanatory diagram illustrating the abnormality detection system using the server 202 of the example.

The abnormality detection system of the example includes an apparatus 601, and the server 202 (abnormality detection device). The apparatus 601 is provided with at least one sensor, and transmits sensor data measured by each sensor provided to the apparatus 601 to the server 202.

The server 202 shown in FIG. 4A is the abnormality detection device. The server 202 executes stream processing with respect to the sensor data that is received, and determines whether or not a state of the apparatus 601 is abnormal on the basis of processing results. In addition, the server 202 transmits signals according to determination results to the apparatus 601.

In FIG. 4A, in a case where the server 202 determines that the state of the apparatus 601 is abnormal, the server 202 transmits an apparatus stop signal to the apparatus 601 to stop the apparatus 601. In addition, in a case where the server 202 determines that the state of the apparatus 601 is not abnormal, the server 202 transmits a normality notification signal indicating a normal condition to the apparatus 601.

FIG. 4B shows an explanatory diagram illustrating an abnormality determination method in the abnormality detection system using the server 202 of the example.

A graph shown in FIG. 4B represents a value of sensor data measured in the apparatus 601. In FIG. 4B, the horizontal axis represents time, and the vertical axis represents the value (sensor value) of the sensor data. The value of the sensor data is shown by the graph shown in FIG. 4B.

The server 202 analyzes a sensor value in the past by the query processing by the host CPU 203 to obtain periodicity of the sensor value, and the like. In addition, the server 202 predicts an upper limit 603 and a lower limit 604 of the sensor value at a time at which the sensor data is to be subsequently measured on the basis of the obtained periodicity and the like by the query processing by the host CPU 203.

When newly receiving sensor data, the stream processing unit 304 (query processing unit 413) of the server 202 determines whether or not a value of the newly received sensor data is included within the range (permissible range) of the upper limit 603 and the lower limit 604. In a case where the value of the newly received sensor data is included within the permissible range, the query processing unit 413 determines that the state of the apparatus 601 is normal.

In addition, in a case where the value of the newly received sensor data is not included within the permissible range, the query processing unit 413 determines that the state of the apparatus 601 is abnormal, and transmits the apparatus stop signal to the apparatus 601.

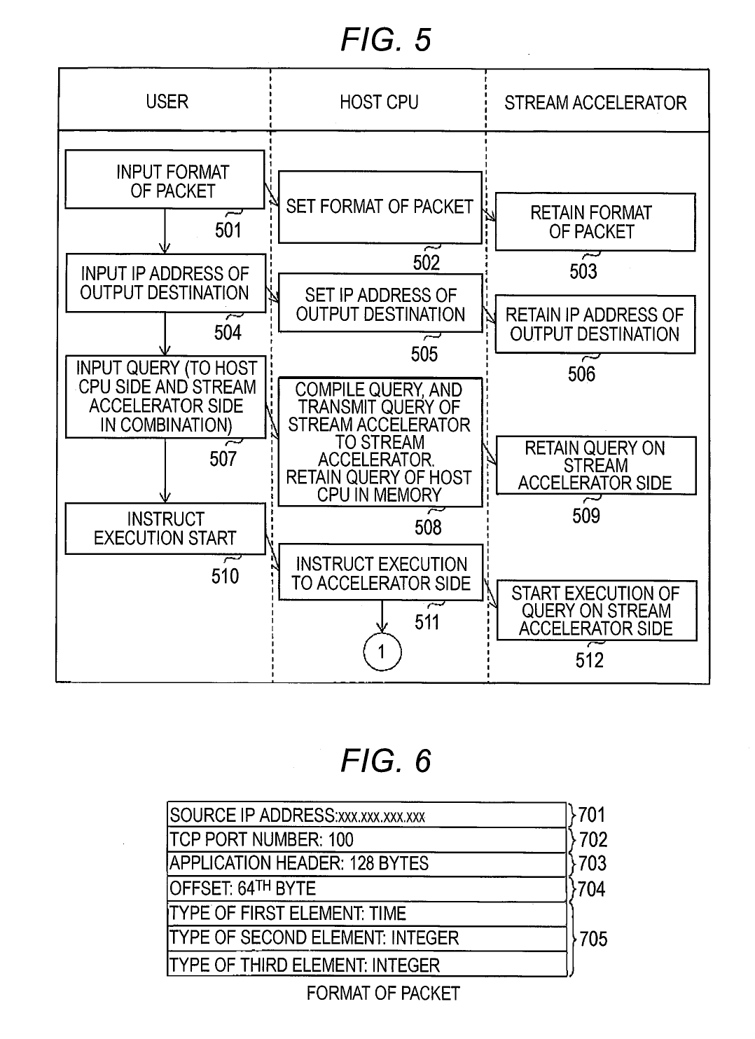

FIG. 5 shows a flowchart illustrating a process of acquiring settings for allowing the stream processing unit 304 of the example to execute stream processing.

A user inputs a format of a packet input to the server 202 to the server 202 using an input device provided to the server 202, or an input device connected to the server 202 (501). For example, the format that is input in step 501 is a format of sensor data in the abnormality detection system shown in FIG. 4A. The format that is input in step 501 represents in which site in the packet is data to be input to the query processing unit 413.

The host CPU 203 inputs the format input by the user to the stream accelerator 201, and sets the format in each processing unit of the stream accelerator 201 (502).

When the format is input from the host CPU 203, the embedded CPU 301 of the stream accelerator 201 sets the input format in the EtherMAC unit 402, the IP processing unit 403, the TCP/UDP processing unit 404, and the data extraction unit 405 of the stream processing unit 304. The EtherMAC unit 402, the IP processing unit 403, the TCP/UDP processing unit 404, and the data extraction unit 405 retain the set format in a storage unit such as a register connected to, or provided to each of these (503).

FIG. 6 shows an explanatory diagram illustrating the format of the packet input to the stream processing unit 304 of the example.

Information related to data necessary for a process by the query processing unit 413 is included in the format of the packet input to the stream processing unit 304. As shown in FIG. 6, for example, the format of the packet includes regions 701 to 705, but it is not limited to the format shown in FIG. 6.

A value indicating a source IP address of data is included in the region 701. In the example shown in FIG. 4A, an IP address of the apparatus 601, or an IP address of sensor data provided to the apparatus 601 is included in the region 701. When determining a source of data included in the input packet, the IP processing unit 403 refers to the region 701.

The region 702 includes a port number that is used by the server 202 to receive a packet from a network to which the server 202 is connected. In the example shown in FIG. 4A, a TCP port number (for example, number 100) for receiving sensor data is included in the region 702.

The number of bytes (for example, 128 bytes) of an application header included in a packet is included in the region 703. In addition, the region 704 includes an offset value indicating at which byte from the end of the application header (for example, 64^{th} byte) data necessary for the query processing unit 413 to execute a process is stored.

The region 705 shown in FIG. 6 illustrates that the first element to the third element from a portion indicated by the offset value of the region 704 are data necessary for the query processing unit 413 to execute a process. In addition, the region 705 shown in FIG. 6 represents that the first element is a TIME type with a fixed byte length which represents time or the like. In addition, the region 705 shown in FIG. 6 represents that the second element and the third element are an INTEGER type with a fixed byte length which represents a numerical value.

When extracting data necessary for the process in the query processing unit 413 from the input packet, the data extraction unit 405 refers to the region 703 to the region 705.

After step 501 in FIG. 5, the user inputs an IP address of a destination, to which results of the stream processing is output, to the server 202 (504). In the example shown in FIG. 4A, the IP address that is input in step 504 is an IP address of the apparatus 601 which is an object to which the apparatus stop signal or the normality notification signal is transmitted.

The host CPU 203 sets the IP address, which is input by the user, to the stream accelerator 201 (505). The IP processing unit 409 of the stream accelerator 201 retains the IP address input by the user (506).

After step 504, the user inputs a query. The query that is input is a program that describes the content which the user wants to execute by stream processing. A program that executes query processing that is executed in the query processing unit 413, and a program that executes query processing that is executed in the host CPU 203 are included in the query that is input.

In the example shown in FIG. 4A, the query processing that is executed in the query processing unit 413 is a process of determining whether or not the value of the sensor data is included within the permissible range whenever the sensor data is input, and of transmitting the apparatus stop signal or the normality notification signal according to the determination results. In addition, the query processing that is executed in the host CPU 203 is a process of accumulating the value of the sensor data in the memory 204, and of obtaining the upper limit and the lower limit on the basis of the value of the accumulated sensor data.

In addition, in the example, the query processing using the accumulated data is executed by the host CPU 203 as described above. This reason is as follows. The processing performance of the host CPU 203 shown in FIG. 1 is higher than the processing performance of the stream processing unit 306, and the capacity of the memory 204 is larger than the capacity of the storage units (DRAM 207 and the like) provided to the stream accelerator 201. That is, the stream accelerator 201 may be a device having a performance lower than the processing performance of the host CPU 203 and a capacity lower than the capacity of the memory 204.

However, in a case where the processing performance of the stream accelerator 201 is sufficiently high, and the capacity of the storage units provided to the stream accelerator 201 is sufficiently large, the stream accelerator 201 may accumulate data, and the stream processing unit 306 may execute the query processing using the accumulated data. That is, the query processing executed by the host CPU 203 may be executed by the query processing unit 413.

The query that is input by the user is compiled by the host CPU 203. The host CPU 203 transmits the query of the stream accelerator 201 which is compiled to the stream accelerator 201. In addition, the host CPU 203 retains the compiled query in the memory 204 of the host CPU 203 (508).

The query processing unit 413 of the stream accelerator 201 retains the transmitted query in a registry provided to the query processing unit 413 itself (509).

After step 507, the user instructs the server 202 to start stream processing (510). When receiving the start instruction from the user, the host CPU 203 instructs the stream accelerator 201 to start the stream processing (511).

When receiving the start instruction from the host CPU 203, the query processing unit 413 initiates the query retained in step 509 (512).

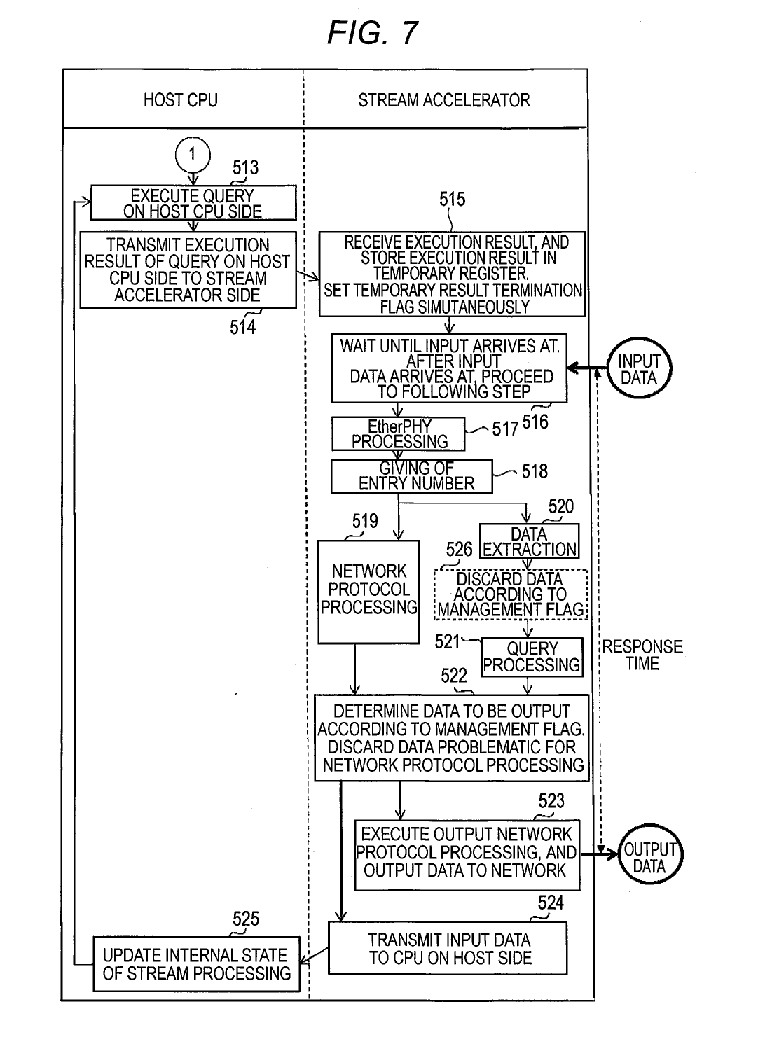

FIG. 7 shows a flowchart illustrating stream processing by the stream processing unit 304 of the example.

After step 511 shown in FIG. 5, the host CPU 203 also initiates the query stored in the memory 204 (513).

After step 513, the host CPU 203 transmits results of the query processing to the stream accelerator 201. In the example shown in FIG. 4A, in a case where the query processing is made to start, the host CPU 203 obtains the upper limit and the lower limit that are within the permissible range of the sensor data from the values of the sensor data accumulated in the memory 204. In addition, the host CPU 203 transmits the upper limit and the lower limit that are obtained to the stream accelerator 201 (514).

The embedded CPU 301 of the stream processor 206 receives the upper limit and the lower limit which are transmitted from the host CPU 203, and stores these in the temporary register 412 of the stream processing unit 304. In addition, the embedded CPU 301 updates the temporary result termination flag 419 by a value indicating that the storage in the temporary register 412 is terminated (515).

After step 515, the EtherPHY unit 401 of the stream accelerator 201 waits until a packet is input through the input network port 208 (516). In the example shown in FIG. 4A, the EtherPHY unit 401 waits until the sensor data output from the apparatus 601 arrives at the input network port 208 of the server 202, and the sensor data is input through the input network port 208.

In a case where the pack is input, the EtherPHY unit 401 converts the input packet from a packet of an analog signal to a packet of a digital signal (517).

After step 517, the entry number giving unit 417 gives an entry number acquired from the entry number generation unit 418 to the packet that is converted into a digital signal. In addition, the entry number giving unit 417 duplicates the packet to which the entry number is given into two pieces. In addition, the entry number giving unit 417 inputs one of the duplicated packets to the data extraction unit 405 (bypass), and inputs the other packet to the EtherMAC unit 402 (518).

In addition, the entry number giving unit 417 updates the management flag 414 in step 518. Details of the updating of the management flag 414 and the entry number will be described later.

When a packet is input from the entry number giving unit 417, the data extraction unit 405 extracts data necessary for query processing from the input packet. In addition, the data extraction unit 405 stores the extracted data necessary for the query processing in the input register 406 (520).

Here, a process that is executed in the data extraction unit 405 will be described.

In general stream processing, an amount of a piece of data that is transmitted to the server 202 so as to execute stream processing once is sufficiently short (small) to a degree capable of being stored in one packet. For example, generally, the sensor data shown in FIG. 4A has a capacity to a degree capable of being stored in a payload portion of one packet, or the like.

Accordingly, in a case where one piece of data among a plurality of pieces of data necessary for stream processing is stored in one packet, the data extraction unit 405 extracts data necessary for the query processing from one packet. In addition, a process in the server 202 in a case where the data necessary for the stream processing is transmitted after being divided into a plurality of packets will be described later.

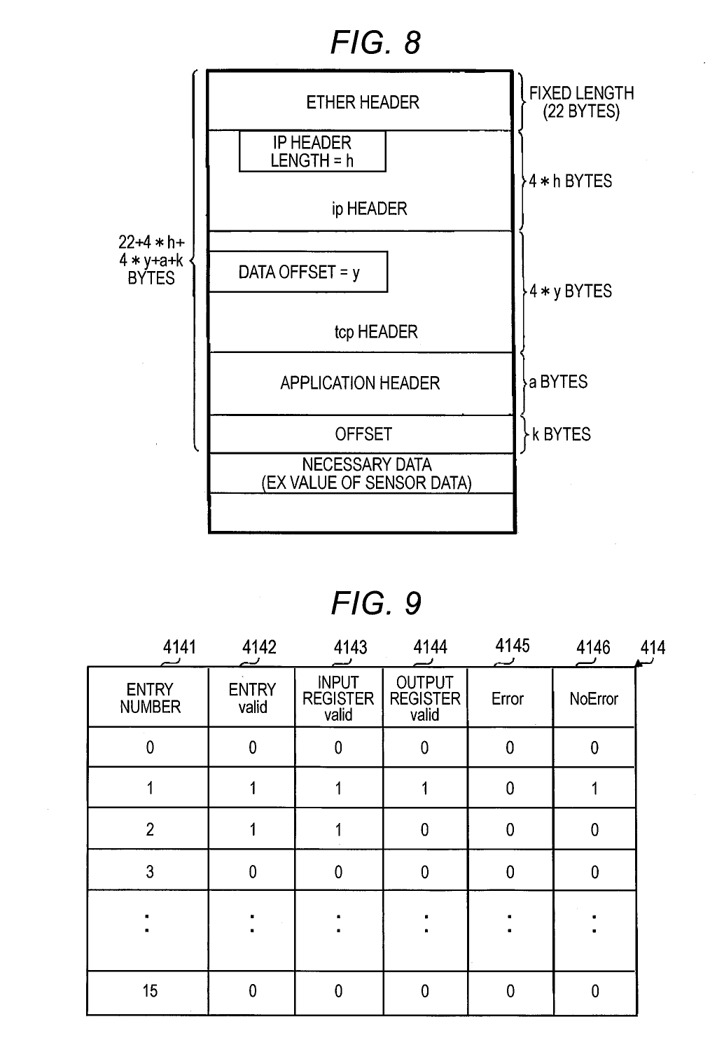

FIG. 8 shows an explanatory diagram illustrating a TCP/IP packet that is received by the stream processing unit 304 of the example.

FIG. 8 shows an example of one packet that is input to the server 202.

A packet output from the EtherPHY unit 401 includes an Ether header at the front of the packet. A length of the Ether header is a fixed length determined by a standard of Ethernet, and is 22 bytes.

The packet in Ethernet includes an IP header after the Ether header. A field indicating an IP header length is included in the IP header. For example, in a case where “h” is stored in the field indicating the IP header length, the IP header length is 4×h bytes.

The packet in Ethernet includes a TCP header after the IP header. A field indicating data offset is included in the TCP header. Here, the data offset is a TCP header length. In a case where “y” is stored in a field indicating the data offset in the TCP header, the TCP header length is Oxy bytes.

In a case where values of the IP header length and the TCP header length are arbitrarily determined, an apparatus that is a packet source (in the example shown in FIG. 4A, the apparatus 601) stores the values of the IP header length and the TCP header length in each packet. According to this configuration, the data extraction unit 405 may discriminate which region in each packet is the IP header, the TCP header, or an application header.

The packet in Ethernet includes the application header after the TCP header. Generally, an application header length is different for each application, but in the example, the user determines the application header length in advance. The application header length in the example is “a” bytes.

The packet in Ethernet includes application data after the application header. Data necessary for stream processing is included in the application data. In the example, the user of the server 202 determines a position of data necessary for the stream processing in the application data in advance. A value of offset of the example is “k” bytes.

The application header length (a) and the offset (k) are stored in the format region 703 and the format region 704 of the packet shown in FIG. 6. The application header length (a) and the offset (k) are retained in the data extraction unit 405 by step 501 to step 503 shown in FIG. 5.

Accordingly, in step 520, the data extraction unit 405 may extract data necessary for stream processing from a position of (22+4×h+4×y+a+k)^{th} byte from the front of the packet.

In step 520, the data extraction unit 405 extracts data necessary for the stream processing from the input packet, and gives an entry number of the input packet to the extracted data. In addition, the data extraction unit 405 specifies the entry number that is given to the extracted data, and stores the extracted data in a storage region of the input register 406 corresponding to the specified entry number.

In step 520, with respect to the packet input to the data extraction unit 405, the network protocol processing is not executed, and data necessary for stream processing is extracted by the data extraction unit 405. Therefore, after step 520, with respect to the input packet, the query processing by the query processing unit 413 is executed earlier than the network protocol processing.

However, a packet having no relation with the stream processing such as a packet not addressed to the server 202 is also included in the packets input to the data extraction unit 405. When the query processing unit 413 executes the query processing with respect to the packet having no relation with the stream processing, and outputs results of the query processing, erroneous results are output.

Accordingly, the stream processing unit 304 in the example executes the network protocol processing in parallel with a process of the data extraction unit 405, and a process of the query processing unit 413 so as not to output erroneous results even in a case of receiving a packet having no relation with the stream processing.

One of the two packets output from the entry number giving unit 417 is input to the EtherMAC unit 402. Then, the EtherMAC unit 402, the IP processing unit 403, and the TCP/UDP processing unit 404 execute the protocol processing of the input network with respect to the input packet (519).

As the protocol processing of the input network, the EtherMAC unit 402 determines whether or not the input data is addressed to own server 202 by a MAC address of the input packet, or determines whether or not an error is present in the input packet according to a CRC method.

In addition, in a case where the input packet is not addressed to the own server 202, or in a case where the input packet is addressed to the own server 202, but a calculated CRC error indicates that there is an error in the packet, the EtherMAC unit 402 determines the input packet as an error. In addition, in a case where the input packet is determined to have an error, the EtherMAC unit 402 updates the management flag 414 to cancel the packet which is by passed and input to the data extraction unit 405 or the data output from the query processing unit 413.

FIG. 9 shows an explanatory diagram illustrating the management flag 414 of the example.

The management flag 414 includes an entry number 4141, entry valid 4142, input register valid 4143, output register valid 4144, Error 4145, and NoError 4146.

The entry number 4141 is a value that is given to data by the entry number giving unit 417.

The entry valid 4142 indicates whether or not a packet to which the entry number is given is input to the data extraction unit 405. In the example, in a case where the entry valid 4142 is “1” (valid), the entry valid 4142 indicates that the packet to which the value of the entry number 4141 is given is input to the data extraction unit 405.

The input register valid 4143 indicates whether or not the data to which the value of the entry number 4141 is given is stored in the input register 406. In the example, in a case where the input register valid 4143 is “1” (valid), the input register valid 4143 indicates that the data to which the value of the entry number 4141 is given is stored in the input register 406.

The output register valid 4144 indicates whether or not the data to which the value of the entry number 4141 is given is stored in the output register 407. In the example, in a case where the output register valid 4144 is “1” (valid), the output register valid 4144 indicates that the data to which the value of the entry number 4141 is given is stored in the output register 407.

The Error 4145 indicates whether or not the packet to which the value of the entry number 4141 is given is determined to have an error in the protocol processing of the input network. In the example, in a case where the Error 4145 is “1” (valid), the Error 4145 indicates that the packet to which the value of the entry number 4141 is given is determined to have an error by the protocol processing of the input network.

The input register control unit 415 determines whether or not a value that is stored in the input register 406 is to be input to the query processing unit 413 according to a value that is stored in the Error 4145, and the output register control unit 416 also determines whether or not a value that is stored in the output register 407 is to be output from the server 202 according to a value that is stored in the Error 4145.

The NoError 4146 indicates whether or not the packet to which the value of the entry number 4141 is given is determined not to have an error in the protocol processing of the input network. In the example, in a case where the NoError 4146 is “1” (valid), the NoError 4146 indicates that the packet to which the value of the entry number 4141 is given is determined not to have an error in the protocol processing of the input network.

The entry number giving unit 417 gives an entry number to a packet in step 518, and specifies a row of the management flag 414 that is indicated by the entry number 4141 using the number that is given to the packet. In addition, the entry number giving unit 417 stores “1” in the entry valid 4142 of the specified row, and stores “0” in other columns (input register valid 4143, output register valid 4144, Error 4145, and NoError 4146) of the specified row. According to this, the entry number giving unit 417 initializes the management flag 414.

The entry number that is stored in the entry number 4141 has a lower limit and an upper limit, and in the example, the lower limit of the entry number is 0, and the upper limit of the entry number is 15. In this case, as the entry number, 16 kinds of numbers may be present.

The upper limit of the entry number is the number of packets capable of being simultaneously processed by the stream accelerator 201. In addition, the upper limit of the entry number corresponds to the number of storage regions provided to the input register 406.

Whenever receiving a packet, the entry number giving unit 417 of the example increments an entry number that is given to the packet according to a number that is generated by the entry number generation unit 418. In addition, after the number that is given to the packet reaches the upper limit of the entry number, the entry number giving unit 417 returns the number given to the packet to the lower limit.

In addition, the entry number giving unit 417 may give the entry number to the packet according to any method as long as the entry number that is given to the packet has the lower limit and the upper limit. For example, whenever receiving a packet, the entry number giving unit 417 may decrement the entry number that is given to the packet.

With regard to the protocol processing of the input network in step 519, in a case where the packet input to the EtherMAC unit 402 is determined to have an error, the EtherMAC unit 402 specifies a row of the management flag 414 corresponding to the entry number that is given to the packet that has an error, and updates the Error 4145 of the specified row with “1”. In addition, the EtherMAC unit 402 also executes error processing (packet discarding and the like) according to the protocol processing.

In a case where the input packet is determined not to have an error in the EtherMAC unit 402, the IP processing unit 403 determines whether or not a destination IP address of the input packet indicates own server 202, and whether or not the source IP address of the input packet is a predetermined address. In addition, the predetermined address that is used to determine the source IP address corresponds to a value that is stored in the region 701 of the packet format which is retained in step 501 to step 503 shown in FIG. 5.

In a case where the destination IP address of the packet that is input does not indicate the own server 202, or the source IP address of the packet that is input is not a predetermined address, the IP processing unit 403 determines that the input packet has an error. In addition, in a case where the packet that is input has an error, the IP processing unit 403 executes error processing such as packet discarding or updating of the management flag 414.

Specifically, in a case where the input packet is determined to have an error in the IP processing unit 403, as is the case with the EtherMAC unit 402, the IP processing unit 403 updates the Error 4145 of the management flag 414 with “1”.

In a case where the input packet is determined not to have an error in the IP processing unit 403, the TCP/UDP processing unit 404 determines whether or not the input packet has an error. An error determination sequence in the TCP/UDP processing unit 404 is shown below.

For example, in a case where the server 202 uses the TCP protocol, the TCP/UDP processing unit 404 determines whether or not a value of the TCP header of the input packet is a predetermined TCP port number. In addition, in a case where the value of the TCP header is the predetermined TCP port number, the TCP/UDP processing unit 404 determines that the input packet is data to be processed in the own server 202.

Here, the predetermined TCP port number corresponds to a value of the region 702 of the packet format which is retained in step 503.

In a case where it is determined that the input packet is not data to be processed in the own server 202, the TCP/UDP processing unit 404 determines that the input packet has an error, and executes error processing such as packet discarding and updating of the management flag 414. Specifically, in a case where it is determined that the input packet has an error, as is the case with the EtherMAC unit 402 and the IP processing unit 403, the TCP/UDP processing unit 404 updates the Error 4145 of the management flag 414 with “1”.

Even in a case where it is determined that the input packet is data to be processed in the own server 202, the TCP/UDP processing unit 404 determines whether or not the data included in the input packet is data to be subjected to stream processing according to the format (other than TCP port number) of the packet which is retained in advance.

In a case where it is determined that the data included in the input packet is not data to be subjected to stream processing, the TCP/UDP processing unit 404 determines that the input data has an error, and executes error processing such as packet discarding, and updates the Error 4145 of the management flag 414 with “1”.

In addition, in a case where error check by a checksum is executed with respect to the input packet, and results of the error check indicate an error, the TCP/UDP processing unit 404 determines that the input packet has an error. In addition, in a case where it is determined that the input packet has an error, the TCP/UDP processing unit 404 executes error processing such as packet discarding, and updates the Error 4145 of the management flag 414 with “1”.

In addition, in a case in which data necessary for the stream processing is transmitted after being divided into a plurality of packets, the TCP/UDP processing unit 404 executes the following process. In addition, in the following description, a plurality of packets that include the data necessary for the stream processing in a divided manner are described as a packet group.

Generally, a sequence number is given to the TCP header of a packet. Accordingly, the TCP/UDP processing unit 404 may detect an abnormality such as several packets in the packet group disappearing on a network, and the packets included in the packet group arriving in a different sequence on the basis of the sequence number.

From results obtained by referring to the sequence number, in a case where the abnormality is detected, the TCP/UDP processing unit 404 determines that the input packet group has an error, and updates the Error 4145 of the management flag 414 which corresponds to each packet of the packet group with “1”. In addition, the TCP/UDP processing unit 404 makes a request for re-transmission of a packet group to a data transmission side.

Furthermore, from results obtained by referring to the sequence number, in a case where the abnormality is not detected, the TCP/UDP processing unit 404 assembles respective pieces of data included in the packet group to one piece of data on the basis of sequence numbers corresponding to the respective pieces of data. In addition, the TCP/UDP processing unit 404 updates data of a packet including the leading sequence number with data that is assembled. In addition, the TCP/UDP processing unit 404 specifies an entry number (at least one) that is given to the packet including the sequence number other than the leading sequence number among the packet group, and updates the Error 4145 of a row including the entry number 4141 indicating the specified entry number with “1”.

Then, the TCP/UDP processing unit 404 inputs a packet including the leading sequence number and the assembled data to the data extraction unit 405. According to this, the data extraction unit 405 may extract data necessary for the stream processing from the packet that is input by the TCP/UDP processing unit 404 in an assembled state.

On the other hand, even in a case where a packet including a sequence number other than the leading sequence number is processed by the data extraction unit 405 and the query processing unit 413 before the assembling processing of the data by the TCP/UDP processing unit 404, since the management flag 414 is updated, processing results related to the packet including the sequence number other than the leading sequence number are discarded at least in the output register 407.

In addition, before the packet including the leading sequence number and the data that is assembled is input to the data extraction unit 405, the TCP/UDP processing unit 404 updates the output register valid 4144 of the management flag 414 corresponding to the packet including the leading sequence number with “0”. According to this, the TCP/UDP processing unit 404 may prevent data stored in the output register 407 from being output from the server 202 by the output register control unit 416 during the processing of the assembled data by the query processing unit 413 in a state in which processing results of the query processing unit 413 with respect to a packet that is input from the entry number giving unit 417 by bypassing the protocol processing are previously input to the output register 407.

The TCP/UDP processing unit 404 processes the data that is transmitted after being divided into the plurality of packets according to the above-described method. Accordingly, the TCP/UDP processing unit 404 may transmit data necessary for the query processing to the query processing unit 413 in an appropriate manner.

In a case where it is determined that the input packet does not have an error, the TCP/UDP processing unit 404 specifies a row of the management flag 414 including the entry number 4141 indicating an entry number of the input packet, and updates the NoError 4146 of the specified row with “1”.

In a case where it is determined that the input packet does not have an error, the TCP/UDP processing unit 404 may discard the packet that is determined not to have an error. According to this, the TCP/UDP processing unit 404 may prevent the data extraction unit 405 and the query processing unit 413 from executing an unnecessary process.

In this manner, the protocol processing (corresponding to step 519) of the input network is terminated.

In step 520, as is the case with the packet input from the entry number giving unit 417, the data extraction unit 405 extracts data necessary for the query processing from the packet input from the TCP/UDP processing unit 404, and inputs the extracted data to the input register 406. In a case where an entry number shown in FIG. 9 is given to the packet, the input register 406 of the example has 16 storage regions (the upper limit of the entry number of the example +1).

In step 520, the data extraction unit 405 updates the input register valid 4143 of a row of the management flag 414 including the entry number 4141 indicating the entry number which is given to the packet with “1”.

After step 520, the input register control unit 415 fetches data stored in the input register 406 in a sequence of an entry number that is allocated to a storage region so as to allow the query processing unit 413 to process data in a packet arrival sequence. Here, the input register control unit 415 determines whether or not to fetch data input to the query processing unit 413 from the input register 406 according to the management flag 414 and a predetermined input condition, or determines whether or not to read a next storage region (to discard) without fetching data.

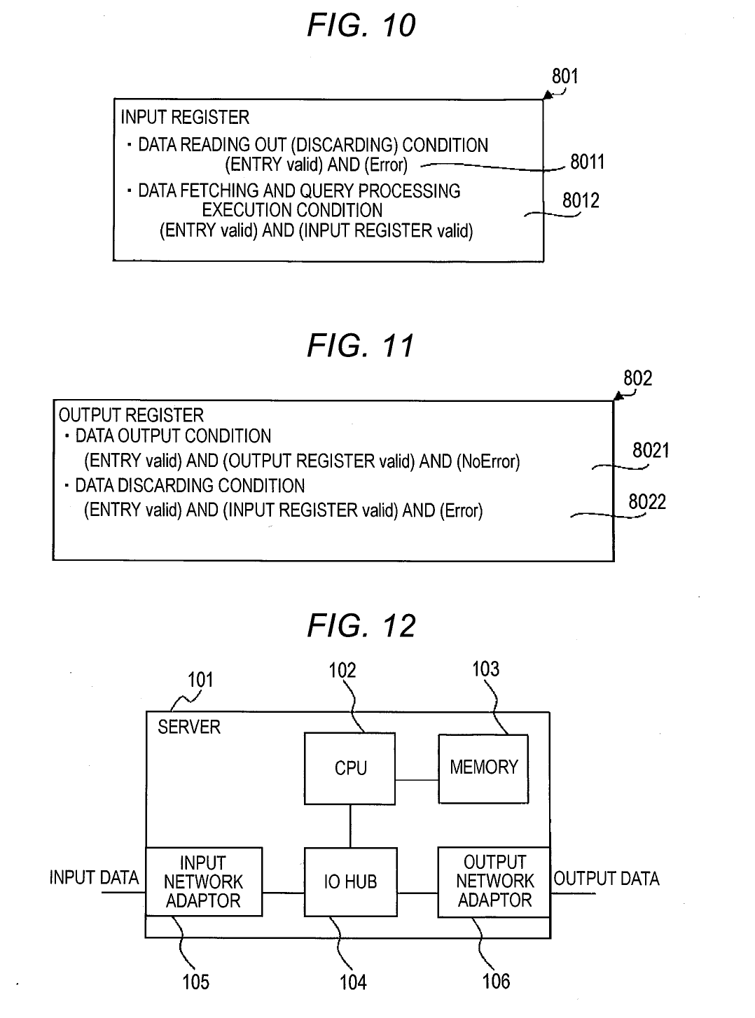

Here, the predetermined input condition 801 for fetching data is shown in FIG. 10.

FIG. 10 shows an explanatory diagram illustrating the input condition 801 for fetching data from the input register 406 of the example.

The input condition 801 is retained in the input register control unit 415 in advance. The input condition 801 shown in FIG. 10 represents a condition 8011 and a condition 8012.

The condition 8011 represents that data in which the entry valid 4142 is valid (“1”), and the Error 4145 is valid (“1”) in the management flag 414 is not fetched from the input register 406. That is, the input register control unit 415 reads a next storage region without fetching data from a storage region of the input register 406 in which data corresponding to the condition 8011 is stored.

Accordingly, the data corresponding to the condition 8011 is overwritten in the input register 406 with data to which the same entry number is given without being processed by the query processing unit 413. That is, in a case where the input register control unit 415 reads data, read-out data is discarded.

The query processing is not executed with respect to data that is determined to have an error in the protocol processing of the input network according to the condition 8011. In a case where data stored in the input register 406 does not correspond to the condition 8011, the input register control unit 415 refers to the condition 8012.

The condition 8012 represents that data in which the entry valid 4142 is valid (“1”), and the input register valid 4143 is valid (“1”) in the management flag 414 is fetched from the input register 406 by the input register control unit 415. In addition, the condition 8012 represents that the fetched data is processed by the query processing unit 413.

Data that is stored in the input register 406 is processed by the query processing unit 413 according to the condition 8012. In addition, since the input condition 801 includes the condition 8011 and the condition 8012, even when the protocol processing of the input network is not terminated, the query processing unit 413 may execute the query processing with respect to data stored in the input register 406.

After step 520, the input register control unit 415 discards data extracted from a packet corresponding to a row in which “1” is stored in the Error 4145 from the input register 406 according to the management flag 414 and the input condition 801 (particularly, the condition 8011) (526). According to this, the input register control unit 415 may discard unnecessary data before a control by the output register control unit 416, and thus an increase in load of the query processing unit 413 due to processing of the unnecessary data by the query processing unit 413 may be suppressed.

The input register control unit 415 fetches data to be processed by the query processing unit 413 according to the condition 8012, and inputs the fetched data to the query processing unit 413.

In addition, in a case where the value of the management flag 414 corresponding to data of the input register 406 does not correspond to any one of the input conditions 801, the input register control unit 415 waits for reading out from the input register 406 without reading a next storage region until the value of the management flag 414 is updated.

In addition, when the input register control unit 415 controls data using the input condition 801, the protocol processing of the input network may not be terminated yet in some cases. Even in this case, it is determined whether or not data output from the query processing unit 413 is to be output from the server 202 according to the results of the protocol processing of the input network by a control of the output register control unit 416 described later. Accordingly, since the input register control unit 415 may also input the data, to which the protocol processing of the input network is not terminated, to the query processing unit 413, the stream processing may be executed at a relatively high speed.

When data is being input, the query processing unit 413 executes the query processing on the basis of the input data and data stored in the temporary register 412 (521). In addition, in step 521, the query processing unit 413 stores data indicating a query processing result in the output register 407. Here, the query processing unit 413 gives an entry number that is given to data input from the input register 406 to the query processing result.

In a case where the temporary result termination flag 419 of the temporary register 412 indicates that storage of data from the host CPU 203 in the temporary register 412 is not terminated, the query processing unit 413 waits for the query processing until the storage of data from the host CPU 203 in the temporary register 412 is terminated. In addition, the query processing unit 413 may store data indicating the query processing result in the temporary register 412.

In the example shown in FIG. 4A, the query processing unit 413 reads out the upper limit and the lower limit (permissible range) stored in the temporary register 412, and compares data (sensor value) input from the input register 406 and the permissible range read out from the temporary register 412 with each other. In a case where the sensor value that is input is included within the permissible range, the query processing unit 413 inputs data indicating normality to the output register 407. In a case where the sensor value that is input is not included within the permissible range, the query processing unit 413 inputs data including a command for stopping an apparatus to the output register 407.

In a case where data of the processing result is stored in the output register 407, the output register control unit 416 updates the output register valid 4144 of the management flag 414 with “1”.

The number of storage regions of the output register 407 is determined according to the content of the stream processing, and is one in the example. The reason of this is as follows. It is necessary for the query processing unit 413 to use an internal state that is updated by data that is received until the previous time for every piece of input data, and thus only one query processing may be executed for one piece of data. As a result, the query processing result by the query processing unit 413 is generally one in many cases.

In addition, even in a case where a plurality of query processing results are calculated from one piece of data, the query processing unit 413 of the example inputs one piece of data including the plurality of query processing results to the output register 407.

In step 521, in a case where data including the query processing result is input to the output register 407, the output register control unit 416 determines whether or not to output data stored in the output register 407 from the server 202 according to the management flag 414 and the output condition 802 shown in FIG. 11 (522). That is, the output register control unit 416 determines data to be discarded without being output from the server 202 according to the management flag 414 and the output condition 802 shown in FIG. 11.

FIG. 11 shows an explanatory diagram illustrating the output condition 802 for fetching data from the output register 407 of the example.

The output condition 802 is retained in the output register control unit 416 in advance. The output condition 802 shown in FIG. 11 represents a condition 8021 and a condition 8022.

The condition 8021 represents that data in which the entry valid 4142 is valid (“1”), the output register valid 4144 is valid (“1”), and the NoError 4146 is valid (“1”) in the management flag 414 is to be output from the server 202.

The condition 8022 represents that data in which the entry valid 4142 is valid (“1”), the input register valid 4143 is valid (“1”), and the Error 4145 is valid (“1”) in the management flag 414 is to be discarded by the output register control unit 416.

That is, the output register control unit 416 inputs data of a result obtained by a process executed by the query processing unit 413 according to the condition 8021 to the TCP/UDP processing unit 408, the result corresponding to a packet determined not to have an error by the protocol processing of the input network.

In addition, the output register control unit 416 discards data corresponding to the condition 8022 so as not to output a query processing result which corresponds to a packet determined to have an error in any protocol processing of the input network from the server 202.

Furthermore, the output register control unit 416 determines that the data of the output register 407 corresponds to either the condition 8021 or the condition 8022, and whether or not to output the data from the server 202, and then the output register control unit 416 updates all rows of the management flag 414 including the entry number 4141 indicating an entry number that is given to the determined data with “0” (522).

In addition, in step 522, in a case where the data of the output register 407 does not correspond to any of the condition 8021 or the condition 8022, the output register control unit 416 waits until the protocol processing of the input network is terminated and the management flag 414 is updated without determining whether or not to output the data of the output register 407 from the server 202.

After step 522, after data is input to the TCP/UDP processing unit 408, the TCP/UDP processing unit 408, the IP processing unit 409, and the EtherMAC unit 410 sequentially execute protocol processing (protocol processing of the output network) for outputting data from the server 202 with respect to the data. According to this, the data output from the output register 407 is included in a packet to be transmitted by the server 202. Particularly, the IP processing unit 409 stores the output destination IP address retained in step 506 in a packet in which the data output from the output register 407 is included.

In addition, in a case where data is input from the EtherMAC unit 410, the EtherPHY unit 411 converts the data from a digital signal to an analog signal, and outputs the data converted to the analog signal to a network through the output network port 209 (523).

Furthermore, after step 522, the output register control unit 416 inputs data of a storage region of the input register 406 to the host CPU 203, the storage region being allocated with the same entry number as that of the data input to the TCP/UDP processing unit 408. In addition, in the stream processing executed by the host CPU 203, the data input to the TCP/UDP processing unit 408 is input to the host CPU 203 as necessary (524).

The host CPU 203 updates the internal state with a new internal state by storing the input data in the memory 204 (525). In a case where the output register control unit 416 determines that the data of the output register 407 is to be output from the server 202, it is possible to prevent data of the packet determined to have an error in the protocol processing of the input network from being added to the internal state by transmitting the data stored in the input register 406 to the host CPU 203. In addition, according to this, the server 202 may retain an appropriate internal state.

In step 521 of the example shown in FIG. 4A, in a case where a value of the sensor data is included within the permissible range, the query processing unit 413 stores data indicating normality in the output register 407, and in a case where the value of the sensor data is not included within the permissible range, the query processing unit 413 stores data including the value of the sensor data, and an apparatus stop command in the output register 407.

In step 522 in the example shown in FIG. 4A, in a case where the management flag 414 indicates that no error is determined by the protocol processing of the input network, the output register control unit 416 inputs data of the output register 407 to the TCP/UDP processing unit 408 so as to transmit data including the apparatus stop command (an apparatus stop signal) or data indicating normality (a normality notification signal) to the apparatus 601. Furthermore, in step 523, the output register control unit 416 transmits data to which the same entry number as the data fetched from the output register 407 is given to the host CPU 203 from the input register 406.

When data is input, the host CPU 203 adds an input value to time-series data of the sensor value that is an internal state of the stream processing, and executes query processing in preparation for input of next sensor data. In the example shown in FIG. 4A, the host CPU 203 calculates a new upper limit 603 and a new lower limit 604.

According to the example, a response time, which is taken before the results of the stream processing are output after data is input to a device that executes the stream processing, may be reduced. Specifically, the protocol processing of the input network (step 519), the data extraction process (step 520), and the query processing 521 are executed in parallel, and thus a time (response time) necessary for processes in step 516 to step 523 shown in FIG. 7 is reduced.

In addition, since whether or not to output the result of the query processing is determined depending on the result of the protocol processing of the input network according to the management flag 414, the stream processing may be correctly executed.

In addition, the above-described example is described in detail for easy explanation of the invention, and it is not necessarily limited to the example including all of the configurations described above.

In addition, a part or the entirety of the above-described respective configurations, functions, processing units, processing processes, and the like may be executed by implementation by a program. In a case where the respective processing units and the like are implemented by the program, a program that realizes functions of the respective processing units, and information such as the input condition 801 may be stored in a recording device such as a memory, a hard disk drive, and an SSD (Solid State Drive), or a recording medium such as an IC card, an SD card, and a DVD.

In addition, in the drawings (particularly, FIG. 3) illustrating the internal configuration of the sever 202 and the like of the example, a control line and an information line represent lines that are considered to be necessary for explanation, and it cannot be said that the control line and the information line indicate all of control lines and information lines installed in light of a product. Practically, it may be considered that almost all of the processing units are connected to each other.

What is claimed is:

1. A stream processing device that executes query processing with respect to data included in a packet input from a network, the stream processing device comprising:
a duplication unit that duplicates the input packet into a plurality of packets;
a protocol processing unit that executes protocol processing corresponding to the network with respect to one packet among the duplicated packets to determine whether or not an error is present in the packet;
a storage unit that stores a management flag indicating a result of determination by the protocol processing;
a data extraction unit that extracts data necessary for the query processing from another packet among the duplicated packets;
a query processing unit that executes the query processing with respect to the extracted data, and outputs data including a result of the query processing; and
an output control unit that determines whether or not to output the data, which is output from the query processing unit, from the stream processing device on the basis of the management flag.

2. The stream processing device according to claim 1, further comprising:
an input control unit that determines whether or not to input the extracted data to the query processing unit,
wherein in a case where the management flag retains the result of determination by the protocol processing, the input control unit determines whether or not to input the extracted data to the query processing unit according to the management flag.

3. The stream processing device according to claim 1, further comprising:
an input register that retains the extracted data,
wherein the query processing unit,
acquires a result of predetermined processing using accumulated data among the extracted data, and
executes the query processing on the basis of the acquired result of the processing and the extracted data, and
wherein in a case where it is determined that the data output from the query processing unit is to be output from the stream processing device to the network, the output control unit determines that the extracted data that is retained in the input register is to be accumulated.

4. The stream processing device according to claim 3,
wherein the packet includes a sequence number, and
wherein when receiving a plurality of the packets in which data necessary for the query processing is included in each of the packets in a divided manner,
the protocol processing unit,
combines data included in each of the plurality of packets on the basis of the sequence number,
updates data included in a first packet among the plurality of packets with the combined data,
inputs the first packet including the combined data to the data extraction unit, and
updates the management flag in such a manner that a result obtained by executing the query processing with respect to data extracted from a second packet included in the plurality of packets other than the first packet is not output from the steam processing device.

5. A server that executes query processing with respect to data included in a packet input from a network, the server comprising:
a duplication unit that duplicates the input packet into a plurality of packets;
a protocol processing unit that executes protocol processing corresponding to the network with respect to one packet among the duplicated packets to determine whether or not an error is present in the packet;
a storage unit that stores a management flag indicating a result of determination by the protocol processing;
a data extraction unit that extracts data necessary for first query processing from another packet among the duplicated packets;
a first query processing unit that executes the first query processing with respect to the extracted data, and outputs data including a result of the first query processing; and
an output control unit that determines whether or not to output the data, which is output from the first query processing unit, from the server on the basis of the management flag.

6. The server according to claim 5, further comprising:
an input control unit that determines whether or not to input the extracted data to the first query processing unit,
wherein in a case where the management flag retains the result of determination by the protocol processing, the input control unit determines whether or not to input the extracted data to the first query processing unit according to the management flag.

7. The server according to claim 5, further comprising:
an input register that retains the extracted data,
a data accumulation unit that accumulates the extracted data, and
a second query processing unit that executes second query processing with respect to the data accumulated in the data accumulation unit,
wherein the first query processing unit executes the first query processing on the basis of a result of processing by the second query processing unit and the extracted data, and
wherein in a case where it is determined that the data output from the first query processing unit is to be output from the server to the network, the output control unit determines that the extracted data that is retained in the input register is to be accumulated in the data accumulation unit.

8. The server according to claim 7,
wherein the packet includes a sequence number, and
wherein when receiving a plurality of the packets in which data necessary for the query processing is included in each of the packets in a divided manner,
the protocol processing unit,
combines data included in each of the plurality of packets on the basis of the sequence number,
updates data included in a first packet among the plurality of packets with the combined data,
inputs the first packet including the combined data to the data extraction unit, and
updates the management flag in such a manner that a result obtained by executing the first query processing with respect to data extracted from a second packet included in the plurality of packets other than the first packet is not output from the server.

9. A stream processing method by a stream processing device that includes a processor and a memory and executes query processing with respect to data included in a packet input from a network, the method comprising:
a duplication process of allowing the processor to duplicate the input packet into a plurality of packets,
a protocol processing process of allowing the processor to execute protocol processing corresponding to the network with respect to one packet among the duplicated packets to determine whether or not an error is present in the packet;
a storage process of allowing the processor to store a management flag indicating a result of determination by the protocol processing in the memory;
a data extraction process of allowing the processor to extract data necessary for the query processing from another packet among the duplicated packets;
a query processing process of allowing the processor to execute the query processing with respect to the extracted data, and to output data including a result of the query processing; and
an output control process of allowing the processor to determine whether or not to output the data, which is output in the query processing process, from the stream processing device on the basis of the management flag.

10. The stream processing method according to claim 9, further comprising:
an input control process of allowing the processor to determine whether or not to input the extracted data to the query processing process,
wherein in a case where the management flag retains the result of determination by the protocol processing, the input control process includes a process of allowing the processor to determine whether or not to input the extracted data to the query processing process according to the management flag.

11. The stream processing method according to claim 9,
wherein the stream processing device further includes an input register that retains the extracted data,
wherein the query processing process includes,
a process of allowing the processor to acquire a result of predetermined processing using accumulated data among the extracted data, and
a process of allowing the processor to execute the query processing on the basis of the acquired result of the processing and the extracted data, and
wherein in a case where it is determined that the data output by the query processing process is to be output from the stream processing device to the network, the output control process includes a process of determining accumulation of the extracted data that is retained in the input register.

12. The stream processing method according to claim 11,
wherein the packet includes a sequence number, and
wherein when the processor receives a plurality of the packets in which data necessary for the query processing is included in each of the packets in a divided manner,
the protocol processing process includes,
a process of allowing the processor to combine data included in each of the plurality of packets on the basis of the sequence number,
a process of allowing the processor to update data included in a first packet among the plurality of packets with the combined data,
a process of allowing the processor to input the first packet including the combined data to the data extraction process, and
a process of allowing the processor to update the management flag in such a manner that a result obtained by executing the query processing with respect to data extracted from a second packet included in the plurality of packets other than the first packet is not output from the steam processing device.
